(19) United States
(12) Patent Application Publication
(10) Pub. No.: US 2016/0298559 A1
(43) Pub. Date: Oct. 13, 2016

(54) ENGINE START CONTROL APPARATUS

(71) Applicant: TOYOTA JIDOSHA KABUSHIKI KAISHA, Toyota-shi (JP)

(72) Inventor: Koki MATSUSHITA, Mishima-shi (JP)

(73) Assignee: TOYOTA JIDOSHA KABUSHIKI KAISHA, Toyota-shi (JP)

(21) Appl. No.: 15/092,232

(22) Filed: Apr. 6, 2016

(30) Foreign Application Priority Data
Apr. 9, 2015 (JP) 2015-080284

(51) Int. Cl. F02D 41/06; F02N 11/08

(52) U.S. Cl. CPC F02D 41/065; F02N 11/0862; F02N 11/087; F02D 2200/503; F02N 2300/2002

(57) ABSTRACT

An engine start control apparatus for a vehicle in which an engine can be automatically stopped temporarily is characterized in that when the position of a piston is within a range that is likely to cause ignition during automatic stop of the engine (Yes in step S3), it is predicted that the electric power consumed in a starting device in restarting the engine is small, a second path with a large resistance is selected as an energization path from a battery to a starter motor (step S4), and starter start for cranking the engine by the starting device and ignition start based on fuel injection and ignition are executed (step S5) to restart the engine.

### INCORPORATION BY REFERENCE

The disclosure of Japanese Patent Application No. 2015-080284 filed on Apr. 9, 2015 including the specification, drawings and abstract is incorporated herein by reference in its entirety.

### BACKGROUND OF THE INVENTION

1. Field of the Invention

The invention relates to an engine start control apparatus.

2. Description of Related Art

Conventionally, there is known a control apparatus that automatically stops an engine of a vehicle when a predetermined automatic stop condition is fulfilled.

For example, it is described in Japanese Patent Application Publication No. 2010-23660 (JP 2010-23660 A) that an engine is restarted upon fulfillment of a predetermined restart condition through the cranking by an electric motor and the combustion of fuel when prompt restart is prepared during automatic stop of the engine, and only through the cranking by the electric motor when prompt restart is not prepared during automatic stop of the engine.

It should be noted herein that there is an anxiety about an early deterioration in the electric motor (a starting device) resulting from an increase in the frequency of use of the electric motor in a vehicle in which the engine described in Japanese Patent Application Publication No. 2010-23660 (JP 2010-23660 A) can be automatically stopped and started. However, Japanese Patent Application Publication No. 2010-23660 (JP 2010-23660 A) does not take a deterioration in the electric motor into account, and there is room for improvement.

### SUMMARY OF THE INVENTION

In view of the aforementioned circumstances, the invention provides an engine start control apparatus that can enhance the durability of a starting device and reliably restart an engine.

Thus, according to one aspect of the invention, there is provided an engine start control apparatus for a vehicle that is equipped with an engine, a battery and a starting device. The starting device is configured to consume an electric power of the battery to start the engine. The engine start control apparatus is equipped with a changeover device, a prediction determination unit, a start request determination unit, a start control unit and a changeover control unit. The changeover device is configured to change over an energization path from the battery to an electric motor of the starting device, between a first path and a second path. A resistance of the second path is larger than a resistance of the first path. The prediction determination unit is configured to (i) determine whether or not a predetermined prediction condition is fulfilled during automatic stop of the engine, and (ii) predict that an electric power consumed in the starting device in restarting the engine is smaller when the prediction condition is fulfilled than when the prediction condition is not fulfilled. The start request determination unit is configured to determine whether or not a start request to start the engine is detected during the automatic stop. The start control unit is configured to (i) execute two kinds of start control out of first start control, second start control and third start control when the start request determination unit determines that the start request is detected and the prediction determination unit determines that the prediction condition is fulfilled, and (ii) restart the engine. The first start control cranks the engine by the starting device. The second start control rotates a crankshaft through fuel injection and ignition. The third start control rotates the crankshaft with the aid of an external force that is transmitted from a driving wheel to the engine via a motive power transmission system. The changeover control unit is configured to execute changeover control for selecting the second path as the energization path when the first start control is included in the two kinds of start control executed by the start control unit.

According to the engine start control apparatus as described above, two kinds of start control out of the first start control, the second start control and the third start control are executed when the prediction condition is fulfilled. Therefore, the electric power consumed by the starting device can be held smaller than when the engine is restarted only through the first start control. Furthermore, a driving current can be supplied to the electric motor of the starting device through the second path with a relatively large resistance. Besides, the frequency of use of the starting device can be reduced by executing the second start control and the third start control to restart the engine. Accordingly, the second path with the large resistance is selected when the electric motor is used. Thus, the driving current supplied to the electric motor can be suppressed, and the frequency of use of the starting device can be suppressed. Therefore, the durability of the starting device can be enhanced.

Besides, the aforementioned engine start control apparatus may be further equipped with a piston position detection unit that is configured to detect a position of a piston of the engine. The prediction condition may include, as a first condition, that the position of the piston is within an ignition range in which an exhaust valve is closed in an expansion stroke. Moreover, the prediction determination unit may be configured to determine whether or not the first condition is fulfilled. When the start request determination unit determines that the start request is detected and the prediction determination unit determines that the first condition is fulfilled, the changeover control unit may be configured to execute changeover control for selecting the second path as the energization path, and the start control unit may be configured to execute the first start control and the second start control.

In the engine start control apparatus as described above, the piston is stopped at the position within the ignition range in which the exhaust valve is closed in the expansion stroke. Therefore, the loss of energy can be suppressed, and an engine torque for raising the rotational speed of the engine can be output, by executing the second start control in restarting the engine. In this case, the second path with the relatively large resistance is selected, so the driving current supplied to the electric motor can be suppressed. Accordingly, the durability of the starting device can be enhanced.

Besides, the aforementioned engine start control apparatus may be further equipped with a vehicle speed detection unit that is configured to detect a vehicle speed. The prediction condition may include, as a second condition, that the vehicle speed is equal to or higher than a predetermined threshold. The prediction determination unit may be configured to determine whether or not the second condition is fulfilled. When the start request determination unit determines that the start request is detected and the prediction determination unit determines that the first condition is not fulfilled and that the second condition is fulfilled, the changeover control unit may be configured to execute changeover control for selecting the second path as the energization path, and the start control unit may be configured to execute the first start control and the third start control.

According to the engine start control apparatus as described above, the vehicle speed is equal to or higher than the predetermined threshold. Therefore, the rotational speed of the engine can be raised with the aid of the external force that is transmitted from the driving wheel to the engine in restarting the engine. Thus, the electric power consumed in the starting device in restarting the engine can be suppressed. Also, since the second path is selected, the driving current supplied to the electric motor can be suppressed. Accordingly, the durability of the starting device can be enhanced.

Besides, the aforementioned engine start control apparatus may be further equipped with a vehicle speed detection unit that is configured to detect a vehicle speed, and a brake detection unit that is configured to detect an operation amount of a brake pedal. Moreover, the prediction condition may include, as a third condition, that the vehicle speed is equal to or higher than a predetermined threshold, and that the brake pedal is depressed. The prediction determination unit may be configured to determine whether or not the third condition is fulfilled. The start control unit may be configured to execute the second start control and the third start control, when the start request determination unit determines that the start request is detected and the prediction determination unit determines that the first condition is fulfilled and that the third condition is fulfilled.

According to the engine start control apparatus as described above, the vehicle speed is equal to or higher than the predetermined threshold, and the brake is ON. Therefore, a driver can be restrained from developing a feeling of strangeness due to a change in acceleration caused in executing the third start control. In short, the acceleration decreases when pushing start (the third start control) is executed during running. Therefore, a change in acceleration unintended by the driver is caused. However, in addition to the vehicle speed that is equal to or higher than the predetermined threshold, the brake pedal is depressed by the driver. Therefore, even when the acceleration decreases through pushing start, such a large change in acceleration as to make the driver develop a feeling of strangeness is not caused. On top of that, the rotational speed of the engine can be raised with the aid of the external force that is transmitted from the driving wheel to the engine in restarting the engine. Furthermore, the engine can be restarted without using the starting device. Therefore, the frequency of use of the starting device can be suppressed, and the durability of the starting device can be enhanced.

Still further, in the aforementioned engine start control apparatus, when the start request determination unit determines that the start request is detected and the prediction determination unit determines that the first condition is fulfilled and that the third condition is not fulfilled, the changeover control unit may be configured to execute changeover control for selecting the second path as the energization path, and the start control unit may be configured to execute the first start control and the second start control.

According to the engine start control apparatus as described above, when it is predicted upon fulfillment of the prediction condition that the electric power consumed in the starting device in restarting the engine is small, two kinds of start control out of the first start control for cranking the engine by the starting device, the second start control for carrying out fuel injection and ignition, and the third start control for rotating the crankshaft with the aid of the external force from the driving wheel side are executed. Furthermore, the energization path from the battery to the electric motor of the starting device is configured to be changed over to the second path with the relatively large resistance, when the first start control is included in the two kinds of start control. Thus, the driving current supplied to the electric motor in restarting the engine is suppressed, and the frequency of use of the starting device is suppressed. Therefore, the durability of the starting device can be enhanced.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a flowchart showing the flow of start control of an engine start control apparatus according to the first embodiment as an example of the invention;

FIG. 2 is an illustrative view schematically showing an energization path from a battery to a starter motor to which the engine start control apparatus according to the embodiment of the invention is applied;

FIG. 3A is a valve timing diagram for illustrating that the position of a piston of an engine to which the engine start control apparatus according to the embodiment of the invention is applied is within a range that is likely to cause ignition;

FIG. 3B is an illustrative view for illustrating an ignition range of the engine;

FIG. 4 is a general view of a vehicle and the engine start control apparatus according to the first embodiment of the invention;

FIG. 5 is a flowchart showing the flow of start control according to the second embodiment of the invention; and

FIG. 6 is a general view showing a vehicle and the engine start control apparatus according to the second embodiment of the invention.

### DETAILED DESCRIPTION OF EMBODIMENTS

An engine start control apparatus according to each of the embodiments of the invention will be described hereinafter concretely, with reference to the drawings.

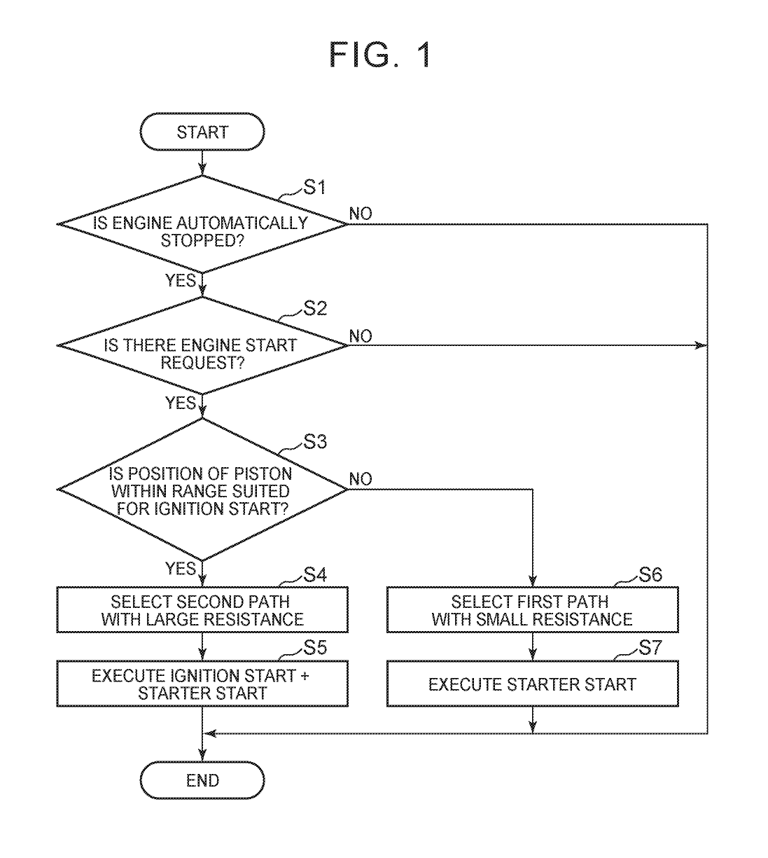

The engine start control apparatus according to the first embodiment of the invention will be described with reference to FIGS. 1 to 4.

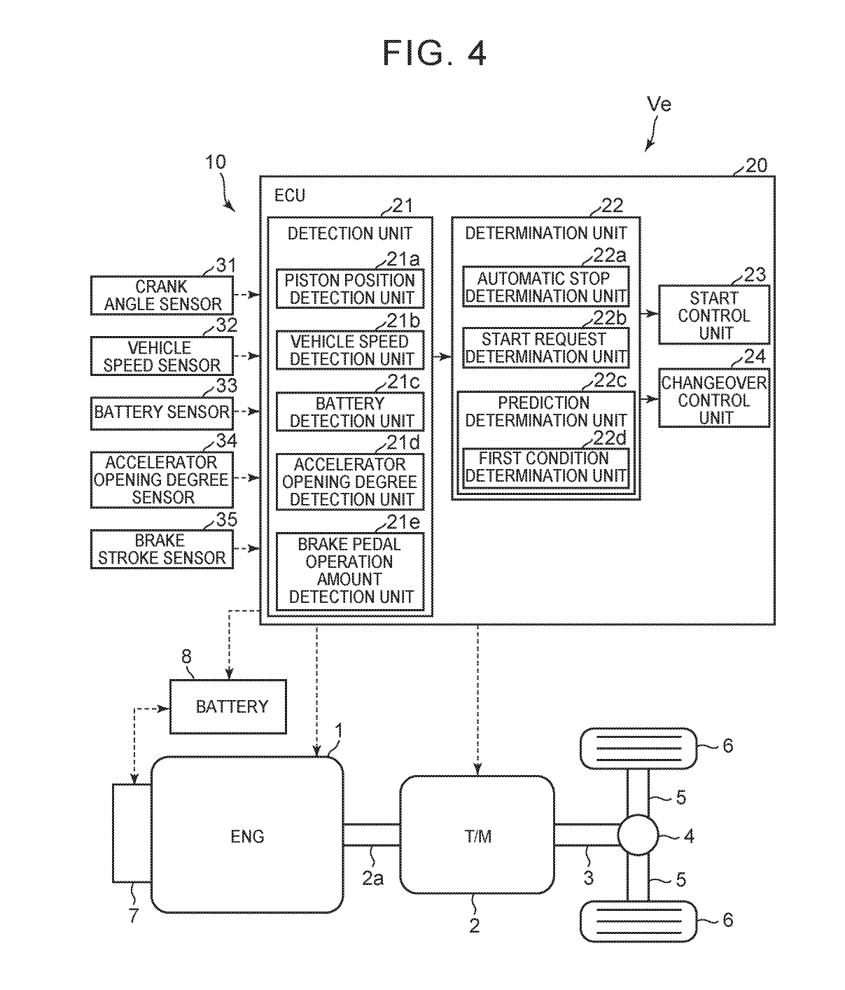

FIG. 4 is a general view showing a vehicle and the engine start control apparatus according to the first embodiment of the invention. A vehicle Ve as a subject of the first embodiment of the invention is equipped with an engine (ENG) 1 as a motive power source, an automatic transmission (T/M) 2, an output shaft 3, a differential 4, an axle 5, and driving wheels 6. The engine 1 is a well-known internal combustion engine such as a gasoline engine, a diesel engine or the like, and is configured as a direct injection type in which fuel is injected into cylinders. The automatic transmission 2 is a well-known transmission that can automatically change the speed ratio and that can be automatically set in a neutral state.

In the vehicle Ve, a crankshaft (not shown) of the engine 1 is connected to an input shaft 2a of the automatic transmission 2. Besides, a motive power output from the engine 1 is transmitted to the output shaft 3 via the automatic transmission 2. The output shaft 3 is coupled to the axle 5 and the driving wheels 6 via the differential 4 in such a manner as to enable the transmission of motive power. Incidentally, the engine 1 may be connected to the automatic transmission 2 in such a manner as to enable the transmission of torque, via a hydraulic power transmission (a torque converter) that operates to amplify the torque through the flow of a fluid.

The vehicle Ve is equipped with a starting device 7 that consumes the electric power of the battery 8 to start the engine 1. Although not shown in FIG. 4, the starting device 7 has an electric motor (hereinafter referred to as “a starter motor”) 71 that cranks the engine 1. The battery 8 is a well-known secondary battery. Besides, the starting device 7 is connected in such a manner as to enable the exchange of electric power with the battery 8 via an inverter (not shown).

An engine start control apparatus 10 is equipped with an electronic control unit (hereinafter referred to as “an ECU”) 20 that controls the vehicle Ve. The ECU 20 is mainly constituted of a microcomputer, and executes arithmetic operations according to a predetermined program based on input data and data stored in advance. Besides, signals output from a crank angle sensor 31, a vehicle speed sensor 32, a battery sensor 33, an accelerator opening degree sensor 34, and a brake stroke sensor 35 are input to the ECU 20.

The crank angle sensor 31 detects a crank angle and an engine rotational speed (a rotational speed of the crankshaft), and outputs a crank angle signal. The vehicle speed sensor 32 detects a vehicle speed (a rotational speed of the axle 5 and a rotational speed of the driving wheels 6), and outputs a vehicle speed signal. The battery sensor 33 detects a voltage of the battery 8 (a battery voltage), a charge current, a discharge current and an internal resistance, and outputs a battery signal. The accelerator opening degree sensor 34 detects an accelerator pedal operation amount, and outputs an accelerator opening degree signal. The brake stroke sensor 35 detects an operation amount of a brake pedal, and outputs a brake signal. Incidentally, signals from various sensors (not shown) such as a sensor that detects a rotational speed of the input shaft 2a, a sensor that detects that the automatic transmission 2 is in a neutral state, and the like are also input to the ECU 20.

The ECU 20 is equipped with a detection unit 21 that detects input signals from the respective sensors 31 to 35, a determination unit 22 that determines, based on a detection result of the detection unit 21 or the like, whether or not various conditions are fulfilled, a start control unit 23 that restarts the engine 1, and a changeover control unit 24 that changes over an energization path from the battery 8 to a starter motor 71.

The detection unit 21 is equipped with a piston position detection unit 21a, a vehicle speed detection unit 21b, a battery detection unit 21c, an accelerator opening degree detection unit 21d, a brake pedal operation amount detection unit 21e. The piston position detection unit 21a detects a crank angle and a position of the piston based on the crank angle signal from the crank angle sensor 31. The vehicle speed detection unit 21b detects a current vehicle speed based on the vehicle speed signal from the vehicle speed sensor 32. The battery detection unit 21c detects a battery voltage, a battery current and a state of charge (SOC) of the battery 8 based on the battery signal from the battery sensor 33. The accelerator opening degree detection unit 21d detects an operation amount of an accelerator pedal and the presence or absence of an operation of the pedal (an accelerator is ON or the accelerator is OFF) based on the accelerator opening degree signal from the accelerator opening degree sensor 34. The brake pedal operation amount detection unit 21e detects an operation amount of the brake pedal and the presence or absence of an operation of the pedal (a brake is ON or the brake is OFF) based on the brake signal from the brake stroke sensor 35. The detection unit 21 outputs detection results of the respective detection units 21a to 21e to the determination unit 22.

The determination unit 22 is equipped with an automatic stop determination unit 22a, a start request determination unit 22b, and a prediction determination unit 22c. The automatic stop determination unit 22a determines whether or not the engine 1 is automatically stopped. The start request determination unit 22b determines whether or not an engine start request according to a driver's request or a system's request is detected. The prediction determination unit 22c determines whether or not a predetermined prediction condition is fulfilled during automatic stop of the engine. The prediction condition is a condition that makes it possible to predict, based on a state of the vehicle during automatic stop of the engine, that the electric power consumed in the starting device 7 in restarting the engine is smaller than when the prediction condition is not fulfilled. That is, the prediction determination unit 22c is configured to predict that the engine 1 can be restarted with a relatively small electric power, by determining whether or not the prediction condition is fulfilled. Besides, a first condition determination unit 22d that determines whether or not a first condition as the prediction condition is satisfied is included in the prediction determination unit 22c. Incidentally, the details of the prediction condition, the first condition and prediction control will be described later.

If the start request determination unit 22b determines that an engine start request is detected, the start control unit 23 executes engine start control. If the prediction determination unit 22c determines that the prediction condition is satisfied, the changeover control unit 24 executes changeover control for changing over the energization path from the battery 8 to the starter motor 71. Incidentally, these kinds of control will be described later in detail.

The ECU 20 outputs a command signal based on a result of various arithmetic operations, and controls in-vehicle devices to be controlled (the engine 1, the automatic transmission 2, the starting device 7, the battery 8, the inverter and the like). For instance, the ECU 20 controls the amount of fuel supplied to the engine 1, the amount of intake air, the injection of fuel, the timing of ignition and the like. Fuel injection and ignition can be carried out in the respective cylinders independently of one another through the control by the ECU 20. As for the ignition timing, fuel injection and ignition can be carried out once in each of the cylinders while the crankshaft rotates twice. Furthermore, the ECU 20 executes the control for automatically stopping the engine 1 temporarily in accordance with the state of the vehicle. The control includes those referred to as so-called stop-and-start control (S&S control), economy-running control, idling stop control and the like. Those kinds of control will be comprehensively described as “S&S control” in the present description.

The ECU 20 executes S&S control upon fulfillment of a predetermined execution condition, and returns from S&S control to restart the engine 1 upon fulfillment of a predetermined return condition. That is, S&S control is designed to execute engine automatic stop control (hereinafter referred to simply as “automatic stop control”) for automatically stopping the engine 1 upon fulfillment of a predetermined automatic stop condition (a execution condition), and to execute engine start control (hereinafter referred to simply as “start control”) for restarting the engine 1 upon fulfillment of a predetermined restart condition (a return condition).

Automatic stop control includes fuel cut control for stopping the injection of fuel into the engine 1 and the ignition of the engine 1. Besides, the automatic stop condition is fulfilled while the vehicle Ve is stopped or runs. That is, the ECU 20 can execute S&S control while the vehicle Ve is stopped or runs. For example, S&S control includes stop S&S control for automatically stopping the engine 1 while the vehicle Ve is stopped waiting for a traffic light to change etc., deceleration S&S control for automatically stopping the engine 1 while the vehicle Ve decelerates to make a stop, and free-run S&S control for automatically stopping the engine 1 while the vehicle Ve runs at or above a certain vehicle speed.

Stop S&S control is executed by depressing the brake pedal (the brake is ON) when the vehicle speed is “0”. The engine 1 is restarted by returning the brake pedal (the brake is OFF) during stop S&S control. Deceleration S&S control is executed by returning the accelerator pedal (the accelerator is OFF) and depressing the brake pedal (the brake is ON) while the vehicle Ve runs at or below a predetermined vehicle speed. The engine 1 is started by returning the brake pedal (the brake is OFF) or depressing the accelerator pedal (the accelerator is ON) during deceleration S&S control. Free-run S&S control is executed by returning the accelerator pedal (the accelerator is OFF) while the vehicle Ve runs at or above a certain vehicle speed. The engine 1 is started by depressing the accelerator pedal (the accelerator is ON) during free-run S&S control.

In this manner, when the ECU 20 executes S&S control, the determination unit 22 (the start request determination unit 22b) determines, based on the accelerator opening degree signal and the brake signal detected by the detection unit 21 (the accelerator opening degree detection unit 21d and the brake pedal operation amount detection unit 21e), whether or not the automatic stop condition or the restart condition is satisfied. That is, in the ECU 20, when the detection unit 21 detects an engine start request (a driver's request) based on an operation of the pedal and the start request determination unit 22b determines that there is a start request, the start control unit 23 can thereby execute S&S control (start control). In addition, the start control unit 23 can execute S&S control by detecting an engine start request as a system's request. Examples in which the start control unit 23 executes start control in response to a system's request include a case where the battery voltage decreases to become lower than a predetermined restart threshold during automatic stop of the engine (hereinafter referred to simply as “during automatic stop” in some cases), a case where the vehicle speed decreases to become equal to or lower than a predetermined vehicle speed during free-run S&S control, and the like. In these cases, the start request determination unit 22b determines, based on results of detection of the vehicle speed detection unit 21b and the battery detection unit 21c, whether or not there is an engine start request (a system's request).

Start control executed by the start control unit 23 includes two kinds of control, namely, starter start as first start control, and ignition start as second start control. Starter start is start control for cranking the engine 1 by the starter motor 71. Ignition start is start control for rotating the crankshaft through the injection of fuel into the engine 1 and the ignition of the engine 1.

The start control unit 23 can execute control when the engine 1 is restarted by executing only starter start (the first start control), and when starter start (the first start control) and ignition start (the second start control) are simultaneously executed. That is, the start control unit 23 can execute start control for restarting the engine 1, by combining the two kinds of start control (starter start and ignition start).

When ignition start (the second start control) and starter start (the first start control) are simultaneously executed, the engine 1 can be restarted by assisting the cranking by the starting device 7 with the aid of an engine torque resulting from the injection of fuel into the cylinders and the ignition of the cylinders and thus raising the rotational speed of the engine. That is, if a comparison is made in the case where the load in restarting the engine is the same in magnitude, the electric power consumed by the starting device 7 is smaller when starter start (the first start control) is combined with ignition start (the second start control) than when the engine 1 is restarted only through starter start (the first start control).

However, when ignition start (the second start control) is executed in a vehicle state in which a desired magnitude of engine torque is not generated, the engine 1 cannot be restarted in some cases. Thus, the ECU 20 according to the first embodiment of the invention is configured to determine, based on the position (the stop position) of the piston of the engine 1 during automatic stop, whether or not ignition start (the second start control) can be executed.

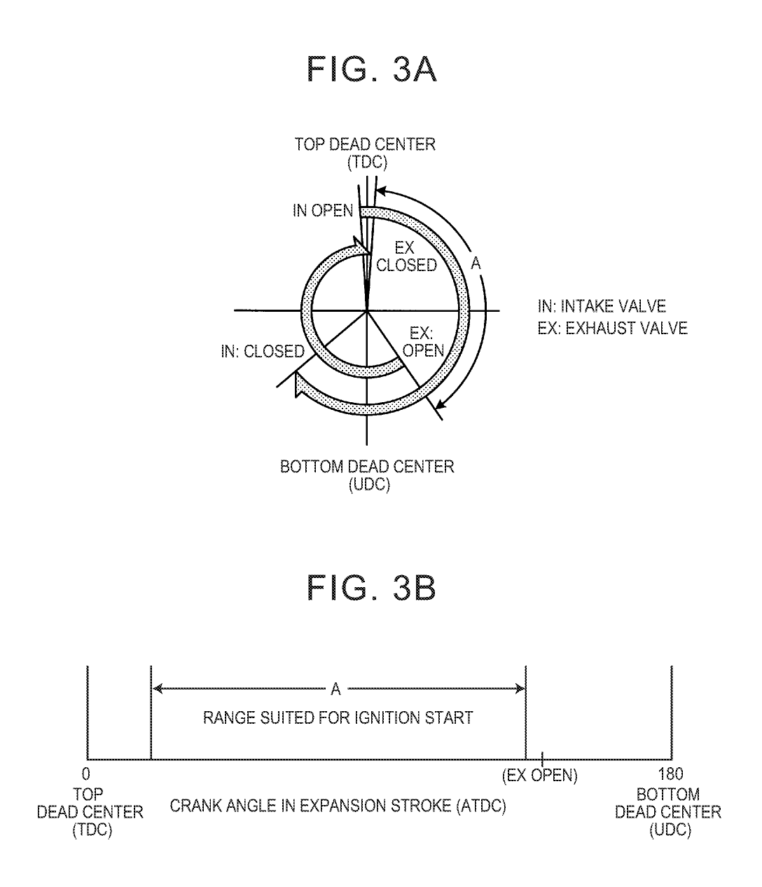

Prediction control, a prediction condition and the first condition will now be described in detail. FIG. 3A is a valve timing diagram for illustrating the stop position of the piston suited for ignition start. FIG. 3B is an illustrative view showing a range suited for ignition start in an expansion stroke.

The ECU 20 can detect, based on the crank angle signal from the crank angle sensor 31 during automatic stop (during S&S control), the position of the piston in each of the cylinders, by means of the piston position detection unit 21a. Therefore, the prediction determination unit 22c determines whether or not the position of the piston is within a range A suited for ignition start (hereinafter referred to as “an ignition range”). The ignition range A is a predetermined range in an expansion stroke. More specifically, even in an expansion stroke, the top dead center as the starting point of the expansion stroke, and the range in which an exhaust valve EX is open in the latter half of the expansion stroke are not included in the ignition range A. That is, the ignition range A can be interpreted as a range other than the top dead center when the exhaust valve EX is closed in the expansion stroke. Accordingly, when it is apparent from the result of determination of the prediction determination unit 22c that the position of the piston is included in the expansion stroke other than the top dead center and that the interior of each of the cylinders is sealed up, the ECU 20 can determine that the piston is stopped at a position suited for ignition start.

For example, in an expansion stroke (ATDC) from a top dead center (TDC) to a bottom dead center (UDC), the starting point of the ignition range A is set in the vicinity of the top dead center. For instance, a crank angle from the top dead center in an intake stroke to the closure of an intake valve IN can be set as the starting point of the ignition range A. In this case, although the timing in the expansion stroke and the timing in the intake stroke are different from each other (e.g., the crank angle in the intake stroke is 360 to 540° when the crank angle in the expansion stroke is 0 to 180°), the crank angle from the top dead center can be expressed as the same magnitude. Besides, it is appropriate that the interior of each of the cylinders be sealed up in the ignition range A. Therefore, the ending point of the ignition range A may be set to a crank angle at which the exhaust valve EX opens, or to a crank angle before the opening of the exhaust valve EX. Incidentally, the intake valve IN obviously remains closed and does not operate in the expansion stroke.

When the position of the piston is within the ignition range A thus set, the start control unit 23 executes ignition start (the second start control), and can apply a desired magnitude of engine torque to the crankshaft in restarting the engine through fuel injection and ignition. Accordingly, the ECU 20 determines, by means of the prediction determination unit 22c, whether or not the position of the piston is within the ignition range A during automatic stop. When the position of the piston is within the ignition range A, the start control unit 23 executes ignition start (the second start control) in restarting the engine. As described above, the electric power consumed in the starting device 7 in restarting the engine is smaller when starter start (the first start control) is assisted with the aid of ignition start (the second start control) than when only starter start is executed. That is, the position of the piston located within the ignition range A means that the electric power consumed in restarting the engine is small. The ECU 20 executes the control (prediction control) for predicting whether or not the electric power consumed in restarting the engine is small during automatic stop, by determining, by means of the prediction determination unit 22c, whether or not the position of the piston is within the ignition range A. The prediction condition for predicting that the electric power consumed in restarting the engine is small includes that the position of the piston is within the ignition range A (the first condition). Accordingly, the prediction determination unit 22c (the first condition determination unit 22d) is configured to determine whether or not the first condition is fulfilled, and predict that the electric power consumed in restarting the engine is smaller when the prediction condition is satisfied for the reason that the position of the piston is within the ignition range A than when the first condition is not fulfilled.

In other words, the small electric power consumed in restarting the engine means that the electric power needed by the starting device 7 in restarting the engine is small. Thus, when the start control unit 23 assists starter start (the first start control) with the aid of ignition start (the second start control), the ECU 20 executes changeover control for changing over an energization path of the starting device 7 to prevent un unnecessarily large current from being supplied to the starting device 7, by means of the changeover control unit 24.

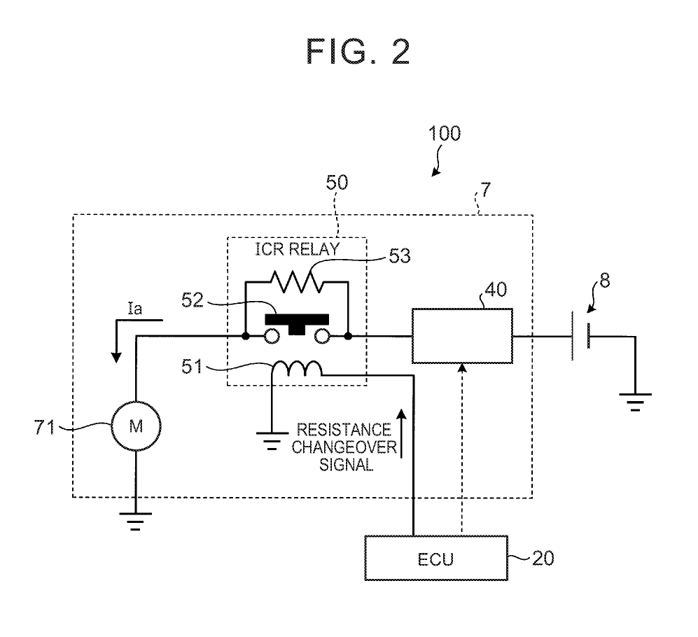

FIG. 2 is an illustrative view schematically showing an electric circuit for illustrating the energization path of the starting device 7. An energization path 100 is a path from the battery 8 as an electric power supply source to the starter motor 71 as an electric power supply destination. The energization path 100 is provided with a starter circuit 40 and an ICR relay 50. The starter circuit 40 is a circuit that has been conventionally employed as an electric circuit for a starter. The ICR relay 50 is a changeover device that is provided between the starter circuit 40 and the starter motor 71. Besides, the battery 8 is connected to the ICR relay 50 via the starter circuit 40, and is connected to the starter motor (M) 71 via the ICR relay 50.

The starter circuit 40 is configured to be able to open/close a main contact point through the excitation of a pull-in coil and a holding coil and the control of the operation of a plunger. When the plunger operates to close the main contact point, a rotor shaft of the starter motor 71 is thereby connected to the crankshaft of the engine 1 via a transmission mechanism (not shown) in such a manner as to enable the transmission of torque. For example, the rotor shaft of the starter motor 71 is provided with a pinion in an integrally rotatable manner. The pinion is configured to mesh with a gear of the aforementioned transmission mechanism via a shift fork that is coupled to the plunger, when the main contact point is closed. In a state where no current is supplied from the battery 8 to the starter circuit 40, the crankshaft and the rotor shaft of the starter motor 71 are not connected to each other in such a manner as to enable the transmission of torque.

The ICR relay 50 is a changeover device having a relay coil 51 that is excited in accordance with a resistance changeover signal output from the ECU 20 that is included in the changeover control unit 24, a relay contact point 52 that is closed through the energization of the relay coil 51, and a resistor 53 that is provided in parallel with the relay contact point 52. In a state where the relay coil 51 is energized (the resistance changeover signal is ON), the relay contact point 52 is closed, so a driving current Ia is supplied from the battery 8 to the starter motor 71 through a path (hereinafter referred to as “a first path”) extending past the relay contact point 52. In a state where the relay coil 51 is not energized (the resistance changeover signal is OFF), the relay contact point 52 is open, so the driving current Ia is supplied from the battery 8 to the starter motor 71 via a path (hereinafter referred to as “a second path”) extending past the resistor 53. Accordingly, the energization path 100 is configured to be changed over between the first path and the second path by the ICR relay 50.

Besides, the first path does not extend past the resistor 53, so the energization path 100 is a path with a relatively small resistance when the first path is selected. The second path extends past the resistor 53, so the energization path 100 is a path with a relatively large resistance when the second path is selected. The resistance of the second path is larger than the resistance of the first path. Therefore, the driving current Ia supplied to the starter motor 71 via the second path is smaller than the driving current Ia supplied to the starter motor 71 via the first path.

The changeover control unit 24 having the ECU 20 executes changeover control for changing over the energization path 100 between the first path and the second path. In concrete terms, when the prediction condition is fulfilled from a result of determination of the prediction determination unit 22c, the changeover control unit 24 opens the relay contact point 52, and executes changeover control for selecting the second path with the large resistance as the energization path 100. On the other hand, when the prediction condition is not fulfilled from a result of determination of the prediction determination unit 22c, the changeover control unit 24 outputs a resistance changeover signal to the relay coil 51, excites the relay coil 51 to close the relay contact point 52, and executes changeover control for selecting the first path with the small resistance as the energization path 100.

FIG. 1 is a flowchart showing the flow of start control executed by the ECU 20. Incidentally, a control routine shown in FIG. 1 is repeatedly executed. The automatic stop determination unit 22a determines whether or not the engine is automatically stopped (step Si). It is determined in step Si whether or not S&S control is in progress. If the result of the determination in step Si is negative for the reason that the engine is not automatically stopped, this control routine is ended.

If the result of the determination in step Si is affirmative for the reason that the engine is automatically stopped, the start request determination unit 22b determines whether or not an engine start request is detected (step S2). It is determined in step S2 whether or not an engine start request is detected without distinguishing between a driver's request and a system's request. If the result of the determination in step S2 is negative for the reason that no engine start request is detected, this control routine is ended.

If the result of the determination in step S2 is affirmative for the reason that an engine start request is detected, the prediction determination unit 22c determines whether or not the piston is stopped at a position within the range suited for ignition start (within the ignition range A) (step S3). The first condition determination unit 22d determines in step S3 whether or not the first condition as the prediction condition is satisfied.

If the result of the determination in step S3 is affirmative for the reason that the position of the piston is within the range suited for ignition start (within the ignition range A) (the prediction condition: fulfilled), the changeover control unit 24 executes changeover control for selecting the second path with the relatively large resistance as the energization path 100 (step S4), and the start control unit 23 executes two kinds of start control, namely, ignition start and starter start (step S5) to restart the engine 1. That is, the driving current Ia supplied to the starter motor 71 is suppressed by the resistor 53 of the ICR relay 50 by selecting the second path in step S4, and starter start based on the relatively small driving current Ia is executed in step S5. Besides, in step S5, starter start (the first start control) and ignition start (the second start control) can be simultaneously started by the start control unit 23. Incidentally, since it is sufficient that ignition start be executed during starter start, the timing for starting starter start and the timing for starting ignition start may not coincide with each other.

If the result of the determination in step S3 is negative for the reason that the position of the piston is not within the range suited for ignition start (outside the ignition range A) (the prediction condition: not fulfilled), the changeover control unit 24 executes changeover control for selecting the first path with the relatively small resistance as the energization path 100 (step S6), and the start control unit 23 executed starter start (step S7) to restart the engine 1. By the processing in step S6, a resistance changeover signal is output from the ECU 20 to the relay coil 51 of the ICR relay 50. Thus, the relay coil 51 is energized, so the relay contact point 52 is closed. In consequence, according to step S6, the driving current Ia is supplied to the starter motor 71 via the relay contact point 52 without passage via the resistor 53 of the ICR relay 50. Therefore, starter start based on the relatively large driving current Ia is executed in step S7. In short, the driving current Ia in executing starter start in step S5 is smaller than the driving current Ia in executing starter start in step S7.

As described above, the engine start control apparatus according to the first embodiment of the invention makes it possible to restrain a surplus current from being supplied to the starting device when it is predicted that the electric power consumed in restarting the engine is small, and hence to enhance the durability of the starting device.

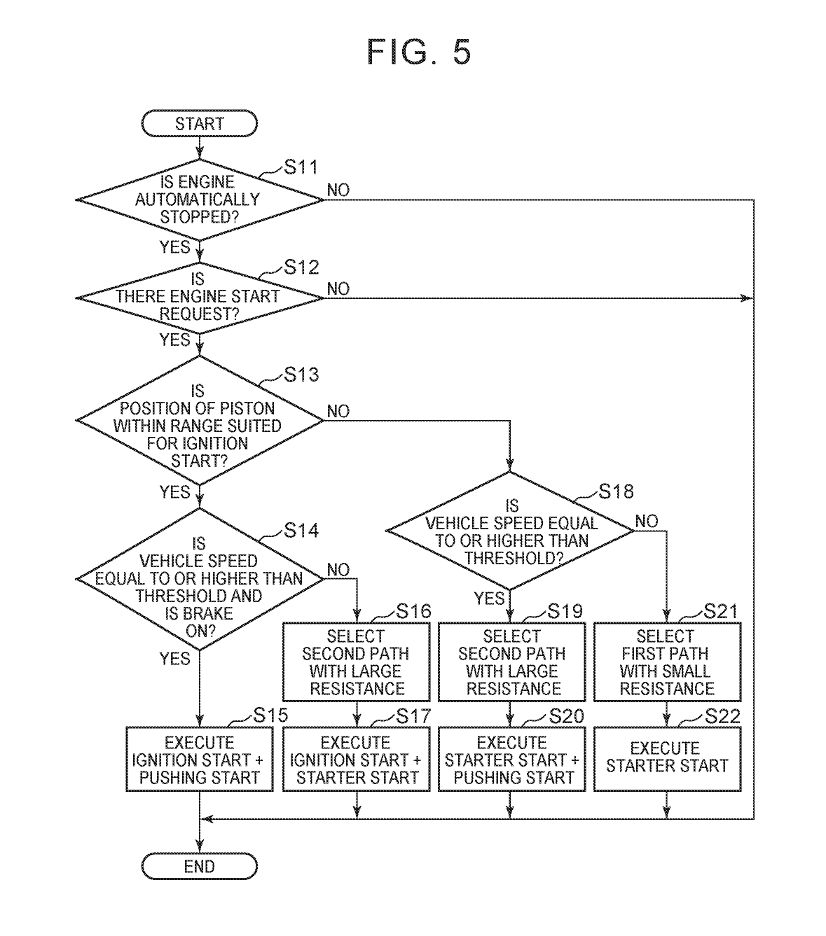

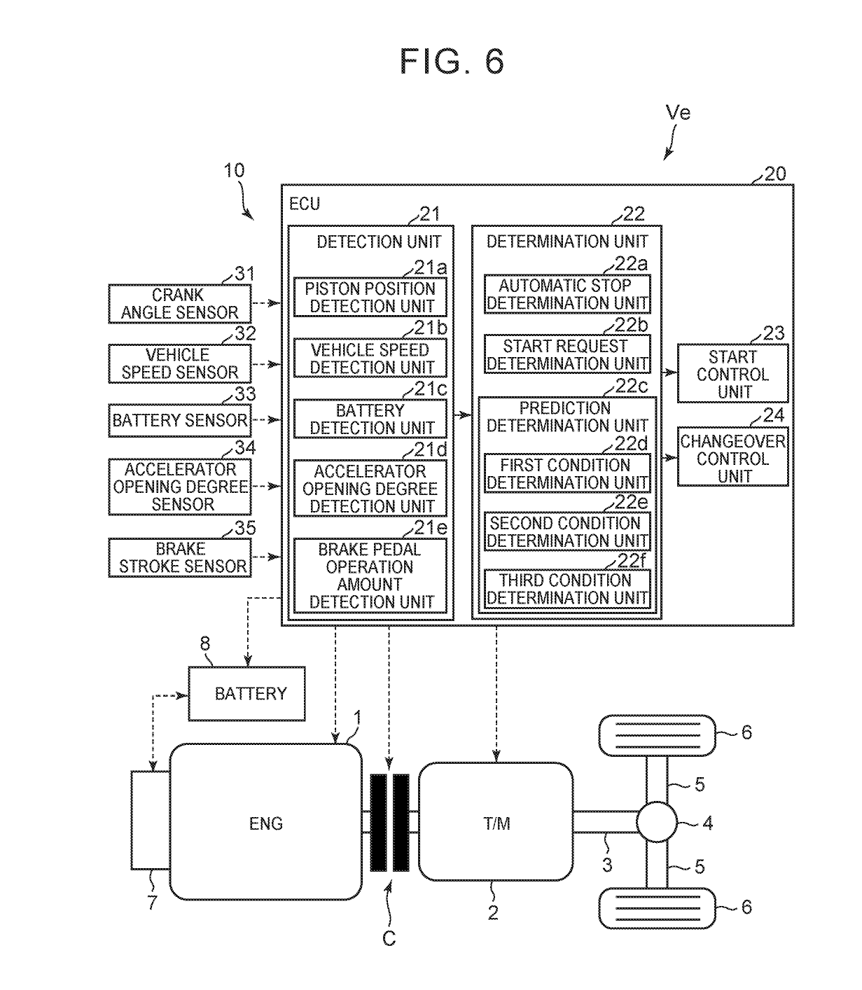

Next, the engine start control apparatus according to the second embodiment of the invention will be described with reference to FIGS. 5 and 6. Incidentally, in the description of the second embodiment of the invention, the same configurational details as in the first embodiment of the invention will not be described, and the same reference symbols as in the first embodiment of the invention will be used.

FIG. 6 is a general view showing a vehicle and the engine start control apparatus according to the second embodiment of the invention. The vehicle Ve is equipped with a clutch C between the engine 1 and the automatic transmission 2 in a motive power transmission path. The clutch C is a friction clutch having a pair of engagement elements that are selectively engaged or released. In the clutch C, one of the engagement elements (a frictional engagement element on an input side) is coupled to the crankshaft of the engine 1, and the other engagement element (a frictional engagement element on an output side) is coupled to the input shaft of the automatic transmission 2. In the vehicle Ve, the engine 1 is decoupled from a motive power transmission system by releasing the clutch C, so no torque can be transmitted between the engine 1 and the driving wheels 6. Besides, the engine 1 is connected to the motive power transmission system by engaging the clutch C, so torque can be transmitted between the engine 1 and the driving wheels 6. Incidentally, an actuator of the clutch C is not limited in particular, and may be a well-known actuator such as a hydraulic actuator, an electromagnetic actuator or the like.

Next, the engine start control apparatus will be described. The ECU 20 is configured to be able to function as a clutch ECU that controls the clutch C. For example, in the case where the clutch C is a hydraulic clutch, the ECU 20 outputs a hydraulic pressure command value to the hydraulic actuator such that a predetermined engagement force is applied to the clutch C. In concrete terms, the ECU 20 is configured to execute clutch control in executing S&S control.

The prediction determination unit 22c is equipped with the first condition determination unit 22d, a second condition determination unit 22e and a third condition determination unit 22f. The second condition determination unit 22e determines whether or not a second condition as the prediction condition is satisfied. The third condition determination unit 22f determines whether or not a third condition as the prediction condition is satisfied. In addition to the aforementioned first condition (that the position of the piston is within the ignition range A), the prediction condition includes that the vehicle speed is equal to or higher than a predetermined threshold as the second condition, and that the vehicle speed is equal to or higher than the predetermined threshold and the brake pedal is depressed (the brake is ON) as the third condition. Incidentally, the details of the respective kinds of prediction control will be described later.

Next, S&S control will be described. When a predetermined automatic stop condition is fulfilled while the vehicle Ve runs, the ECU 20 releases the clutch C as free-run S&S control, and executes fuel cut control for stopping the injection of fuel into the engine 1 and the ignition of the engine 1. Then, when a predetermined restart condition is fulfilled during free-run S&S control (during automatic stop), the start control unit 23 of the ECU 20 engages the clutch C, restarts the engine 1, and makes a return to a state of the vehicle where the torque of the engine can be transmitted to the driving wheels 6. Incidentally, stop S&S control and deceleration S&S control include cases where there is no need to execute clutch control for releasing the clutch C at the time of execution and engaging the clutch C at the time of a return.

During free-run S&S control, the vehicle Ve is in a coasting state and the driving wheels 6 rotate, but the clutch C is released to decouple the engine 1 from the motive power transmission system. Therefore, the driving wheels 6 do not drag and rotate the engine 1. That is, when the clutch C is released during S&S control even while the vehicle Ve runs, the engine 1 is not dragged and rotated by the driving wheels 6 to displace the position of the piston.

Furthermore, the ECU 20 is configured to be able to execute the control for displacing the position of the piston of the engine 1 into the ignition range A by driving the starter motor 71 when the clutch C is released during S&S control. Thus, the position of the piston stopped outside the ignition range A at the time of automatic stop or the like can be displaced into the ignition range A.

Next, start control will be described. Start control executed by the start control unit 23 includes three kinds of control, namely, starter start (the first start control), ignition start (the second start control) and pushing start as third start control. Pushing start is start control for rotating the crankshaft with the aid of an external force that is transmitted from the driving wheels 6 to the engine 1 via the motive power transmission system.

The start control unit 23 is configured to be able to execute control in the case where only starter start (the first start control) is executed, in the case where starter start (the first start control) and ignition start (the second start control) are simultaneously executed, in the case where starter start (the first start control) and pushing start (the third start control) are simultaneously executed, and in the case where ignition start (the second start control) and pushing start (the third start control) are simultaneously executed, in restarting the engine. In short, start control by the start control unit 23 can be classified into the case where two kinds of start control out of the first start control, the second start control and the third start control are executed in parallel, and the case where starter start is executed alone.

In the case where the start control unit 23 simultaneously executes starter start (the first start control) and pushing start (the third start control), the engine 1 is restarted by assisting the cranking by the starting device 7 with the aid of the external force transmitted from the driving wheels 6 and thus raising the rotational speed of the engine. If a comparison is made in the case where the load in restarting the engine is the same in magnitude, the electric power consumed by the starting device 7 is smaller when starter start (the first start control) is combined with pushing start (the third start control) than when the engine 1 is restarted only through starter start (the first start control).

In the case where the start control unit 23 simultaneously executes ignition start (the second start control) and pushing start (the third start control), the engine 1 is restarted by rotating the crankshaft through the ignition of fuel, rotating the crankshaft with the aid of the external force transmitted from the driving wheels 6 and thus raising the rotational speed of the engine. In this case, the engine 1 is restarted without using the starting device 7. Therefore, there is no need to energize the starting device 7 in restarting the engine, and the electric power consumed in restarting the engine can be suppressed. Incidentally, in the case where the start control unit 23 simultaneously executes starter start (the first start control) and ignition start (the second start control), the same as in the first embodiment of the invention holds true, so the description thereof is omitted herein.

Next, prediction control will be described. The prediction determination unit 22c is configured such that the first condition determination unit 22d preferentially executes prediction control for determining whether or not the first condition is satisfied. Then, when the first condition is satisfied, the third condition determination unit 22f executes prediction control for determining whether or not the third condition is satisfied. On the other hand, when the first condition is not fulfilled, the second condition determination unit 22e executes prediction control for determining whether or not the second condition is satisfied.

The case where the first condition is fulfilled and the case where the first condition is not fulfilled will now be described separately. First of all, the case where the first condition is fulfilled for the reason that the position of the piston is within the ignition range A will be described. When the first condition is fulfilled in the first condition determination unit 22d and the third condition is also fulfilled in the third condition determination unit 22f for the reason that the vehicle speed is equal to or higher than the predetermined threshold and the brake is ON, the start control unit 23 executes ignition start (the second start control) and pushing start (the third start control). Besides, when the first condition is fulfilled in the first condition determination unit 22d but the third condition is not fulfilled in the third condition determination unit 22f, the start control unit 23 executes starter start (the first start control) and ignition start (the second start control).

Next, the case where the first condition is not fulfilled will be described. When the first condition is not fulfilled in the first condition determination unit 22d but the second condition is fulfilled in the second condition determination unit 22e for the reason that the vehicle speed is equal to or higher than the predetermined threshold, the start control unit 23 executes starter start (the first start control) and pushing start (the third start control). That is, when the first condition is not fulfilled but the second condition is satisfied, the prediction determination unit 22c predicts that the electric power consumed in restarting the engine is small. On the other hand, when neither the first condition nor the second condition is fulfilled, the prediction determination unit 22c determines that the prediction condition is not satisfied, and predicts that the electric power consumed in restarting the engine is normal. In this case, the start control unit 23 executes only starter start (the first start control) as start control.

In this manner, when the first condition or the second condition is fulfilled, the prediction condition is fulfilled, and it can be predicted that the electric power consumed in restarting the engine is small. Furthermore, the start control unit 23 executes at least ignition start (the second start control) when the first condition is satisfied, and executes at least pushing start (the third start control) when the second condition or the third condition is satisfied. In short, when the prediction condition is fulfilled in the prediction determination unit 22c, the start control unit 23 executes two kinds of start control out of starter start (the first start control), ignition start (the second start control) and pushing start (the third start control) to restart the engine 1.

Next, changeover control will be described. Changeover control according to the second embodiment of the invention will be described. When the result of determination of the prediction determination unit 22c satisfies the prediction condition and starter start (the first start control) is included in the two kinds of start control executed by the start control unit 23, the changeover control unit 24 executes changeover control for selecting the second path with the large resistance as the energization path 100. On the other hand, when the prediction condition is not fulfilled in the prediction determination unit 22c, the start control unit 23 executes only starter start (the first start control) as start control. Therefore, the changeover control unit 24 executes changeover control for selecting the first path with the small resistance as the energization path 100. Incidentally, in the case where the start control unit 23 does not execute starter start (the first start control) even when the prediction condition is satisfied, the starter motor 71 is not energized, so the changeover control unit 24 does not execute changeover control. In addition, the starter circuit 40 is not energized, so the rotor shaft of the starter motor 71 is decoupled from the crankshaft. Therefore, the engine load in restarting the engine can be reduced.

Next, the flow of start control will be described. FIG. 5 is a flowchart showing the flow of start control according to the second embodiment of the invention. Incidentally, steps S11 to S13 shown in FIG. 5 are the same as the aforementioned steps Si to S3 shown in FIG. 1, so the description thereof is omitted herein. A control routine shown in FIG. 5 is repeatedly executed.

The prediction determination unit 22c determines in step S13 whether or not the position of the piston is within the range suited for ignition start (within the ignition range A). In step S13, the first condition determination unit 22d determines whether or not the first condition as the prediction condition is satisfied.

If the result of the determination in step S13 is affirmative (the first condition: fulfilled) for the reason that the position of the piston is within the range suited for ignition start (within the ignition range A), the prediction determination unit 22c determines whether or not the vehicle speed is equal to or higher than the predetermined threshold and the brake is ON (step S14). In step S14, the third condition determination unit 22f determines whether or not the third condition as the prediction condition is satisfied.

If the result of the determination in step S14 is affirmative (the third condition: fulfilled) for the reason that the vehicle speed is equal to or higher than the predetermined threshold and the brake is ON, the start control unit 23 executes two kinds of start control, namely, ignition start and pushing start (step S15) to restart the engine 1. When the first condition is fulfilled and the third condition is fulfilled, ignition start (the second start control) and pushing start (the third start control) can be simultaneously started by the start control unit 23 in step S15, without executing changeover control by the changeover control unit 24. That is, when the start control unit 23 executes step S15, no current is caused to flow from the battery 8 to the energization path 100. Therefore, the main contact point is open, and the starter motor 71 is decoupled from the crankshaft, so ignition start and pushing start can be executed with the engine load in restarting the engine reduced. Thus, the electric power can be restrained from being consumed, and the energy can be restrained from being lost in converting combustion energy into kinetic energy. Incidentally, since it is appropriate that pushing start be executed during ignition start, the timing for starting ignition start and the timing for starting pushing start may not coincide with each other.

If the result of the determination in step S14 is negative (the third condition: not fulfilled) for the reason that the vehicle speed is not equal to or higher than the predetermined threshold or the brake is not ON, the changeover control unit 24 executes changeover control for selecting the second path with the relatively large resistance as the energization path 100 (step S16), and the start control unit 23 executes two kinds of start control, namely, ignition start and starter start (step S17) to restart the engine 1. That is, the driving current Ia supplied to the starter motor 71 is suppressed by the resistor 53 of the ICR relay 50 by selecting the second path in step S16, and starter start based on the relatively small driving current Ia is executed in step S17. Besides, in step S17, starter start (the first start control) and ignition start (the second start control) can be simultaneously started by the start control unit 23.

If the result of the determination in step S13 is negative (the first condition: not fulfilled) for the reason that the position of the piston is not within the range suited for ignition start (outside the ignition range A), the prediction determination unit 22c determines whether or not the vehicle speed is equal to or higher than the predetermined threshold (step S18). In step S18, the second condition determination unit 22e determines whether or not the second condition as the prediction condition is satisfied.

If the result of the determination in step S18 is affirmative (the second condition: fulfilled) for the reason that the vehicle speed is equal to or higher than the predetermined vehicle speed, the changeover control unit 24 executes changeover control for selecting the second path with the relatively large resistance as the energization path 100 (step S19), and the start control unit 23 executes two kinds of start control, namely, starter start and pushing start (step S20) to restart the engine 1. Accordingly, when the start control unit 23 executes two kinds of start control out of the first start control, the second start control and the third start control, the changeover control unit 24 executes changeover control for selecting the second path including the resistor 53 as the energization path 100, in the case where the first start control (starter start) is included in the two kinds of start control.

On the other hand, if the result of the determination in step S18 is negative (the second condition: not fulfilled, the prediction condition: not fulfilled) for the reason that the vehicle speed is not equal to or higher than the predetermined threshold, the changeover control unit 24 executes changeover control for selecting the first path with the relatively small resistance as the energization path 100 (step S21), and the start control unit 23 executes starter start (step S22) to restart the engine 1. By the processing in step S21, a resistance changeover signal is output from the ECU 20 to the relay coil 51 of the ICR relay 50. Thus, the relay coil 51 is energized, so the relay contact point 52 is closed. In consequence, according to step S21, the driving current Ia is supplied to the starter motor 71 via the relay contact point 52 without passage via the resistor 53 of the ICR relay 50. Therefore, starter start based on the relatively large driving current Ia is executed in step S22. In short, the driving current Ia in executing starter start in step S16 and step S19 is smaller than the driving current Ia in executing starter start in step S21.

Incidentally, the ECU 20 is configured to execute the control for engaging the clutch C in conjunction with the aforementioned steps S15, S17, S20 and S22, in the case where S&S control for releasing the clutch C, such as free-run S&S control or the like has been executed.

As described above, the engine start control apparatus according to the second embodiment of the invention can restrain a surplus current from being supplied to the starting device when it is predicted that the electric power consumed in restarting the engine is small and starter start is executed, and hence can enhance the durability of the starting device. Furthermore, even when it is predicted that the electric power consumed in restarting the engine is small, the engine can be restarted without executing starter start. Therefore, the frequency of use of the starting device can be suppressed, so the durability of the starting device can be enhanced.

Incidentally, the engine start control apparatus according to this invention is not limited to the aforementioned respective embodiments of the invention, but can be appropriately modified within such a range as not to depart from the object of this invention.

For example, in each of the aforementioned embodiments of the invention, the configuration in which the energization path 100 is provided with the ICR relay 50 as shown in FIG. 2 has been described, but this invention is not limited thereto. A changeover device that is constituted of other relays and switches may be provided. In short, it is sufficient to adopt a configuration in which the energization path 100 is changed over between a path with a relatively small resistance and a path with a relatively large resistance. The changeover device and changeover control are not limited in particular.

What is claimed is:

1. An engine start control apparatus for a vehicle that is equipped with an engine, a battery and a starting device that consumes an electric power of the battery to start the engine, the engine start control apparatus comprising:
a changeover device configured to change over an energization path from the battery to an electric motor provided in the starting device, between a first path and a second path, a resistance of the second path being larger than a resistance of the first path;
a prediction determination unit configured to:
(i) determine whether or not a predetermined prediction condition is fulfilled during automatic stop of the engine, and
(ii) predict that an electric power consumed in the starting device in restarting the engine is smaller when the prediction condition is fulfilled than when the prediction condition is not fulfilled;
a start request determination unit configured to determine whether or not a start request to start the engine is detected during the automatic stop;
a start control unit configured to:
(i) execute two kinds of start control out of first start control, second start control and third start control when the start request determination unit determines that the start request is detected and the prediction determination unit determines that the prediction condition is fulfilled, the first start control cranking the engine by the starting device, the second start control rotating a crankshaft through fuel injection and ignition, and the third start control rotating the crankshaft with an aid of an external force that is transmitted from a driving wheel to the engine via a motive power transmission system, and
(ii) restart the engine; and
a changeover control unit configured to execute changeover control for selecting the second path as the energization path when the first start control is included in the two kinds of start control executed by the start control unit.

2. The engine start control apparatus according to claim 1, further comprising:
a piston position detector configured to detect a position of a piston of the engine, wherein
the prediction condition includes, as a first condition, that the position of the piston is within an ignition range in which an exhaust valve is closed in an expansion stroke,
the prediction determination unit is configured to determine whether or not the first condition is fulfilled, and
when the start request determination unit determines that the start request is detected and the prediction determination unit determines that the first condition is fulfilled, the changeover control unit is configured to execute changeover control for selecting the second path as the energization path, and the start control unit is configured to execute the first start control and the second start control.

3. The engine start control apparatus according to claim 2, further comprising:
a vehicle speed detector configured to detect a vehicle speed, wherein
the prediction condition includes, as a second condition, that the vehicle speed is equal to or higher than a predetermined threshold,
the prediction determination unit is configured to determine whether or not the second condition is fulfilled, and
when the start request determination unit determines that the start request is detected and the prediction determination unit determines that the first condition is not fulfilled and that the second condition is fulfilled, the changeover control unit is configured to execute changeover control for selecting the second path as the energization path, and the start control unit is configured to execute the first start control and the third start control.

4. The engine start control apparatus according to claim 2, further comprising:
a vehicle speed detector configured to detect a vehicle speed; and
a brake detector configured to detect an operation amount of a brake pedal, wherein
the prediction condition includes, as a third condition, that the vehicle speed is equal to or higher than a predetermined threshold, and that the brake pedal is depressed,
the prediction determination unit is configured to determine whether or not the third condition is fulfilled, and
the start control unit is configured to execute the second start control and the third start control, when the start request determination unit determines that the start request is detected and the prediction determination unit determines that the first condition is fulfilled and that the third condition is fulfilled.

5. The engine start control apparatus according to claim 4, wherein
when the start request determination unit determines that the start request is detected and the prediction determination unit determines that the first condition is fulfilled and that the third condition is not fulfilled, the changeover control unit is configured to execute changeover control for selecting the second path as the energization path, and the start control unit is configured to execute the first start control and the second start control.
